(19) United States
(12) Patent Application Publication
(10) Pub. No.: US 2026/0329897 A1
(43) Pub. Date: Oct. 22, 2026

(54) METHOD, APPARATUS, DEVICE AND PRODUCT FOR DATA CLASSIFICATION AND DATA DETECTION

(71) Applicant: BEIJING ZITIAO NETWORK TECHNOLOGY CO., LTD., Beijing (CN)

(72) Inventor: Haitao YANG, Beijing (CN)

(21) Appl. No.: 19/652,924

(22) Filed: Apr. 20, 2026

(30) Foreign Application Priority Data
Apr. 18, 2025 (CN) 202510497115.4

(51) Int. Cl. G06F 16/28; G06F 16/27

(52) U.S. Cl. CPC G06F 16/287; G06F 16/275

(57) ABSTRACT

The present disclosure relates to a method, an apparatus, a device and a product for data classification and data detection. The method for data classification comprises acquiring data input by a user, a user action, and a state of a user equipment, wherein the user action is associated with a way the user inputs the data. The method comprises determining a category of the data based on the data, the user action and the state. The method for data detection comprises receiving data and a category of the data from a user equipment, wherein the category is determined based on the data, a user action and a state of the user equipment. The method comprises determining a detection result by matching the data and the category with a server database, and sending the detection result to the user equipment.

### CROSS-REFERENCE TO RELATED APPLICATIONS

This application claims priority to Chinese Application No.202510497115.4 filed Apr. 18, 2025, the disclosure of which is incorporated herein by reference in its entirety.

### FIELD

The present disclosure relates to the field of computers, and more specifically, to a method, an apparatus, a device and a product for data classification and data detection.

### BACKGROUND

In the current wave of digitalization, ecosystems of social platforms are flourishing and continuously evolving, giving rise to diverse types of social platforms such as video content platforms, note content platforms, and blog content platforms. Taking video content platforms as an example, from a creator-side perspective, as the technical threshold for entry has been lowered, creator groups of video content are increasingly diversified and create video content covering diverse themes. Meanwhile, by virtue of diversified propagation ways such as a precise algorithm recommendation, video content can swiftly reach the target audience, and the propagation efficiency can be improved.

On the user side, as viewing habits become ingrained, user’s engagement with video content continues to rise, thereby forming a closed loop from watching, liking, and commenting to sharing and even secondary creation, and fostering a virtuous cycle in the video content ecosystem. For instance, user comments provide the user with a platform for discussions centered around video themes, thereby driving the sustained growth of the video content ecosystem.

### SUMMARY

In a first aspect of embodiments of the present disclosure, there is provided a method for data classification. The method comprises acquiring data input by a user, a user action, and a state of a user equipment, wherein the user action is associated with a way the user inputs the data. The method comprises determining a category of the data based on the data, the user action and the state.

In a second aspect of embodiments of the present disclosure, there is provided an apparatus for data classification. The apparatus comprises a data acquisition module configured to acquire data input by a user. The apparatus further comprises a state acquisition module configured to acquire a user action and a state of a user equipment, the user action being associated with a way the user inputs data. The apparatus further comprises a category determination module configured to determine a category of the data based on the data, the user action and the state.

In a third aspect of embodiments of the present disclosure, there is an electronic device. The electronic device comprises a processor and a memory coupled to the processor, the memory having stored therein instructions which, when executed by the processor, cause the electronic device to perform the method according to the first aspect.

In a fourth aspect of embodiments of the present disclosure, there is provided a computer program product having stored thereon computer-executable instructions, wherein the computer-executable instructions are executed by a processor to perform the method in the first aspect.

In a fifth aspect of embodiments of the present disclosure, there is a method for data detection. The method comprises receiving data and a category of the data from a user equipment, wherein the category is determined based on the data, a user action and a state of the user equipment. The method comprises determining a detection result by matching the data and the category with a server database. The method comprises sending the detection result to the user equipment.

In a sixth aspect of embodiments of the present disclosure, there is provided an apparatus for data classification. The apparatus comprises a receiving module configured to receive data and a category of the data from a user equipment, the category being determined based on the data, a user action and a state of the user equipment. The apparatus comprises a matching module configured to determine a detection result by matching the data and the category with a server database. The apparatus comprises a sending module configured to send the detection result to the user equipment.

In a seventh aspect of embodiments of the present disclosure, there is provided an electronic device. The electronic device comprises a processor and a memory coupled to the processor, the memory having stored therein instructions which, when executed by the processor, cause the electronic device to perform the method according to the fifth aspect.

In an eighth aspect of embodiments of the present disclosure, there is provided a computer program product having stored thereon computer-executable instructions, wherein the computer-executable instructions are executed by a processor to perform the method in the fifth aspect.

The Summary is provided to introduce a selection of concepts in a simplified form that are further described below in the Detailed Description. This Summary is not intended to identify key features or essential features of the disclosure, nor is it intended to limit the scope of the disclosure.

### BRIEF DESCRIPTION OF THE DRAWINGS

The above and other features, advantages and aspects of embodiments of the present disclosure will become more apparent with reference to the following detailed description when taken in conjunction with the figures. In the figures, the same or like reference numerals denote the same or like elements, wherein:

FIG. 1 illustrates a schematic diagram of an example environment in which embodiments of the present disclosure may be implemented;

FIGS. 2A-2B illustrate a flow chart of a method for data classification and a flow chart of a method for data detection according to some embodiments of the present disclosure;

FIG. 3 illustrates a schematic diagram of an example timing sequence for classifying and detecting user comments according to some embodiments of the present disclosure;

FIGS. 4A-4B illustrate schematic diagrams of example interfaces for a user to post comments according to some embodiments of the present disclosure;

FIG. 5 illustrates a schematic diagram of an example architecture for training a machine learning model according to some embodiments of the present disclosure;

FIGS. 6A-6B illustrate a block diagram of an apparatus for data classification and an apparatus for data detection according to some embodiments of the present disclosure; and

FIG. 7 illustrates a block diagram of a device capable of implementing various embodiments of the present disclosure.

### DETAILED D ESCRIPTION OF EMBODIMENTS

It may be appreciated that all user-related data involved in this solution should be obtained and used after authorization by the user. This means that, in the present technical solution, if the user personal information needs to be used, before these data is obtained, the user explicit consent and authorization are required, otherwise relevant data collection and use will not be performed. It should also be understood that in the implementation of the present technical solution, relevant laws and regulations should be strictly observed during the collection, use and storage of data, and necessary techniques and measures should be taken to ensure the safety of the user’s data and the safe use of the data.

It may be appreciated that prior to using the technical solutions disclosed in the embodiments of the present disclosure, the user should be notified of the type, scope of use, use scenario, etc. of personal information involved in the present disclosure and authorization be obtained from the user in an appropriate way according to relevant laws and regulations.

For example, in response to reception of the user active request, prompt information is sent to the user to explicitly prompt the user that an operation he requests to perform needs to obtain and use his personal information. Accordingly, the user may autonomously select, according to the prompt information, whether to provide the personal information to software or hardware such as an electronic device, an application, a server or a storage medium, which executes the operations of the technical solution of the present disclosure.

As an optional but non-limiting implementation, in response to reception of the user active request, the prompt message may be sent to the user, for example, in the form of a pop-up in which the prompt message may be presented in a text. In addition, the pop-up may further carry a selection control for the user to select “agree” or “disagree” to provide the personal information to the electronic device.

It is to be understood that the above-described processes of notifying and obtaining the user authorization are merely illustrative and not be construed as limiting the implementations of the present disclosure, and that other ways of satisfying relevant laws and regulations may also be applied to the implementations of the present disclosure.

Hereinafter, embodiments of the present disclosure will be described in more detail with reference to the accompanying drawings. Although certain embodiments of the present disclosure have been illustrated in the accompanying drawings, it is to be understood that the present disclosure may be embodied in various forms and should not be construed as being limited to the embodiments set forth herein; rather, these embodiments are provided to enable the present disclosure to be understood more thoroughly and completely. It should be understood that the drawings and embodiments of the present disclosure are for illustrative purposes only and are not intended to limit the scope of the present disclosure.

In the depictions of the embodiments of the present disclosure, the term “include” and like words should be understood as being open-ended terms, i.e., mean “include, but not limited to”. The term “based on” should be understood as “based, at least in part, on”. The term “one embodiment” or “the embodiment” should be understood as “at least one embodiment”. The terms “first”, “second” and the like may refer to different or identical objects unless expressly stated otherwise. Other explicit and implicit definitions may also be included below.

As stated above, social platforms are continuously evolving, enabling users to interact with other users on the social platforms. Taking a video-based social platform as an example, some users may post their original video content, while other users may interact regarding the video content posted by some users by expressing attitudes or opinions, such as liking, giving a thumbs-down, sharing, or commenting. During the user interactions, such “interactions” may be abstracted into data, i.e., a set of information that characterizes user interaction actions and feedback content on the platform, which may be hereinafter referred to as the data. The data may take a form of multimedia. For example, user comments on the video content may be data in the form of text, and the pictures or stickers posted in response to the video content may be data in the form of pictures.

However, with the rapid advancement of internet technology, some users, driven by profit motives, are exploiting these means of expression to fabricate false attitudes, such as posting fake or malicious comments. Such malicious user actions affect the healthy development of the video content ecosystem. Therefore, it is crucial to identify and detect such data affecting the video content ecosystem.

In the relevant art, the content (i.e., data) expressed by the users to show their attitudes is only detected by a rule matching method to identify whether the data is normal. This conventional rule matching method only typically considers the data itself, and cannot achieve a high accuracy in identification and detection. Moreover, this conventional identification or classification method based on rule matching exhibits a low efficiency.

To this end, the present disclosure provides a method for data classification and a method for data detection. By the methods, the classification and detection can be multi-dimensionally performed on the data, and the accuracy of classification and detection can be improved. According to an embodiment of the present disclosure, first, data input by a user, the user action associated with a data input way and a state of a user equipment are acquired. Then, a classification result of the data, i.e., a category of the data, is comprehensively determined based on the data, the way, and the state. As compared with a single-dimensional analysis, such a multi-dimensional comprehensive determination method can improve the accuracy of classification. After the data and the category of the data are obtained, they may be matched with a database so that a detection result of the data is determined according to a matching result.

Through this multi-dimensional classification and detection method, the efficiency of classifying and identifying the data can be effectively enhanced so as to provide a decision-making basis for subsequent processing of the detection result of the data. Meanwhile, such a method for further detection of the data enhances the accuracy and effectiveness of data detection, and thereby improves normal user experience in interaction actions.

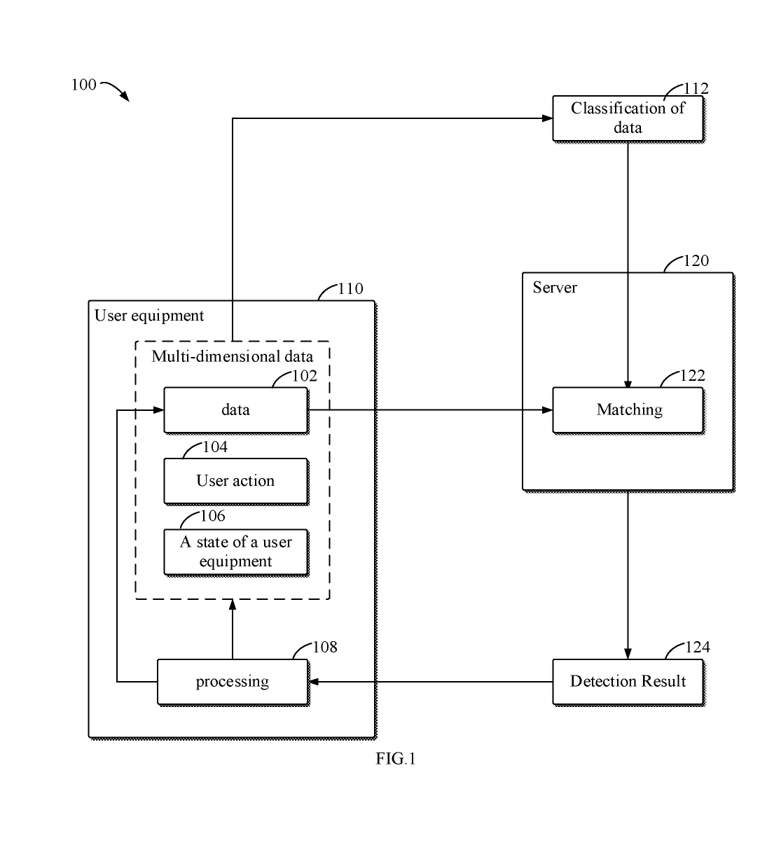

Embodiments of the present disclosure will be described in further detail below with reference to the accompanying drawings. FIG. 1 illustrates a schematic diagram of an example environment 100 in which embodiments of the present disclosure may be implemented. As shown in FIG. 1, the example environment 100 comprises a user equipment 110 and a server 120. The user equipment 110 may acquire a data detection service from the server 120, and the server 120 may acquire a data classification service from the user equipment 110.

As shown in FIG. 1, the user equipment 110 may be any device capable of sending and receiving information, and may be a mobile phone, a tablet computer, a notebook computer, a palmtop computer, a smart television, a Personal Digital Assistant (PDA), a smart printer, a smart home appliance, a vehicle-mounted terminal, a wearable device (a smart watch, a smart bracelet, smart glasses, etc.), a Virtual Reality (VR) device, an Augmented Reality (AR) device, etc. which is not limited by the embodiments of the present disclosure.

Referring to FIG. 1, the user equipment 110 may be used for data classification. In some embodiments, when a user logs in a user account on the user equipment 110 and publishes data under the user account, the data 102 input by the user may be acquired, and the user action 104 and a state 106 of the user equipment may be recorded. In some embodiments, after the aforesaid content is acquired, a data classification operation may be performed based on the data 102, the user action 104 and the state 106 of the user equipment to determine a category 114 of the data based thereon.

In some embodiments, the data 102 may be a set of information characterizing the user interaction actions and feedback content on a platform, and may be data in the form of multimedia. For example, the data may be the user comments, and the data may also be pictures, videos, etc. In some embodiments, the user actions 104 may be forms in which the user inputs the data. For example, when the data is the user comments, the forms may be large-scale copy-pasting, frequent repeated input, regular input, etc. In some embodiments, the state 106 of the user equipment may refer to the state of the user equipment 110, for example, whether the user equipment 110 is in a jailbroken state, whether the user equipment 110 is in a normal state, whether the user equipment 110 is in a limited state, etc. In some embodiments, the categories of data may be classified into high, medium, and low categories, and these categories may be used to indicate a state of compliance of the data with a specific requirement, or to indicate whether the data is normal or abnormal, and to indicate a degree of the abnormality.

Such a method for data classification based on the data and meanwhile in conjunction with the state of user equipment and user actions can ensure the accuracy of data classification and provide an accurate basis for subsequent data detection.

Further referring to FIG. 1, the server 120 may be a computing system, a single server, a distributed server, etc. and the server 120 may be a server that detects data. After the category 112 of the data and the data 102 sent by the user equipment 120 are received, they may be used to perform the operation of matching 122 to determine a detection result 124. The category 112 of the data here is determined multi-dimensionally based on the data 102, the user action 104 and the state 106 of the user equipment. In some embodiments, the matching 122 operation may be implemented by a pattern matching algorithm, or by a machine learning model.

In some embodiments, the category 112 of the received data and the data 102 may be matched with a server database to obtain the detection result 124. The server database may include a lot of samples of the data and data categories corresponding to the data. Taking an example in which the data is user comments on a video, the server database may be a server corpus. The corpus refers to a large-scale electronic text library which has a certain capacity, and collects naturally occurring continuous language use texts or speech segments according to certain linguistic principles.

Meanwhile, after the detection result 124 is determined, the detection result 124 may be sent to the user equipment 110 so that the user equipment 110 may perform the processing 108 operation based on the detection result 124. In some embodiments, the processing 108 operation comprises at least one of processing the data 102, processing a user account logged into the user equipment, or updating the state 106 of the user equipment.

Such a method of performing secondary detection on the preliminarily classified data and the categories of the data at the server can effectively improve the accuracy and effectiveness of the data detection result, and thus can further improve the normal users’ experience.

It should be appreciated that the architecture and functionality in the example environment 100 are described for exemplary purposes only and do not imply any limitation on the scope of the present disclosure. Embodiments of the present disclosure may also be applied to other environments having different structures and/or functions. For example, in some embodiments, the environment 100 may also include a plurality of user equipment which may communicate with each other directly.

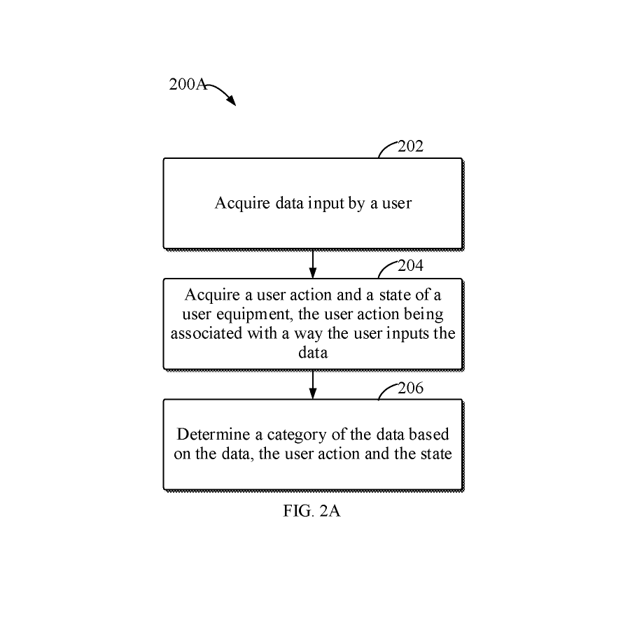

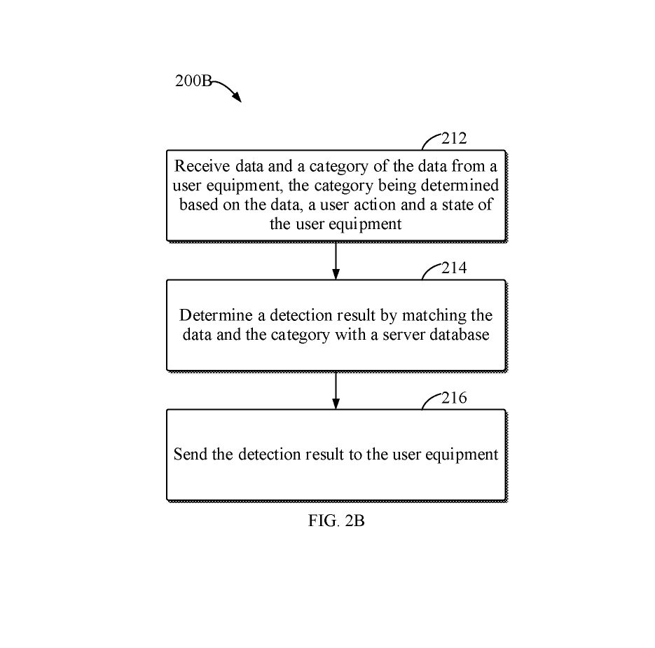

Hereinafter, a method according to an embodiment of the present disclosure will be described in detail with reference to FIG. 2A through FIG. 7. To facilitate understanding, specific data mentioned in the following description is exemplary and is not intended to limit the scope of the present disclosure. It is to be understood that the embodiments described below may also include additional acts not shown and/or may omit the acts shown. The scope of the present disclosure is not limited in this regard.

FIG. 2A illustrates a flow chart of a method 200A for data classification according to some embodiments of the present disclosure. The method 200A may be performed by an apparatus for data classification, and the apparatus may be, for example, a stand-alone apparatus or system. The apparatus may be implemented by means of software and/or hardware. Next, the method 200A will be schematically illustrated taking an apparatus for data classification, such as the user equipment 110 shown in FIG. 1, as an example of an execution body. The method 200A comprises block 202, block 204, and block 206.

As shown in FIG. 2A, at block 202, data input by the user is acquired. Referring to FIG. 1, when the user logs into the user account on the user equipment 110 and posts data under the user account, the data input by the user may be acquired.

At block 204, the user action and the state of the user equipment are acquired, wherein the user action is associated with a way the user inputs the data. Referring to FIG. 1, when the user logs into the user account on the user equipment 110 and posts data under the user account, the user action 104 recorded and associated with the user-input data 102 and the state 106 of the user equipment may be acquired.

At block 206, a category of the data is determined based on the data, the user action, and the state. Referring to FIG. 1, in some embodiments, after the data 102, the user action 104 and the state 106 of the user equipment are acquired, a data classification operation may be performed based on the data 102, the user action 104 and the state 106 of the user equipment so as to determine the category 114 of the data based thereon.

Such a method for data classification based on the data and in conjunction with the state of user equipment and the user action can ensure the accuracy of data classification and provide an accurate basis for subsequent data detection.

FIG. 2B illustrates a flow chart of a method 200B for data detection according to some embodiments of the present disclosure. The method 200B may be performed by an apparatus for data detection, and the apparatus may be, for example, a stand-alone apparatus or system. The apparatus may be implemented by means of software and/or hardware. Next, the method 200B is schematically illustrated by taking an apparatus for data detection, such as the server 120 shown in FIG. 1, as an execution body. The method 200B comprises block 212, block 214, and block 216.

As shown in FIG. 2B, at block 212, data and a category of data are received from the user equipment, where the category is determined based on the data, the user action and the state of the user equipment. Referring to FIG. 1, after a category 112 of the data is determined from the user equipment 110, the user equipment 110 may send the data 102 and the category 112 of the data to the server 120, and the server 120 may receive the data 102 and the category 112 of data sent by the user equipment 110, wherein the category of data is determined multi-dimensionally based on the data 102, the user action 104 and the state 106 of the user equipment.

At block 214, a detection result is determined by matching the data and the category with a server database. Referring to FIG. 1, after the category 112 of data and the data 102 sent by the user equipment 120 are received, they may be used to perform a matching 122 operation to determine a detection result 124. The category 112 of data here is determined multi-dimensionally based on the data 102, the user action 104 and the state 106 of the user equipment. In some embodiments, the category 112 of the received data and the data 102 may be matched with the server database to obtain the detection result 124.

At block 216, the detection result is sent to the user equipment. Referring to FIG. 1, after the detection result 124 IS determined, it may be sent to the user equipment 110.

Such a method of performing secondary detection on the preliminarily classified data and the categories of the data at the server can effectively improve the accuracy and effectiveness of the data detection result, and thus can further improve the normal users’ experience.

The method for multi-dimensionally classifying and detecting data by combining method 200A and method 200B can effectively improve the efficiency of data classification and identification, so as to provide a decision-making basis for subsequent processing of the detection result of the data. Meanwhile, such a method for further detection of the data enhances the accuracy and effectiveness of data detection, and thereby improves normal user experience in interaction actions.

In some embodiments, a machine learning model may be used to perform a data classification operation during data classification. In some embodiments, a pattern matching algorithm and the machine learning model may also be used to perform the data detection operation during data detection. In some embodiments, the data may be the user comment, such as the user textual comment on a video. It may be appreciated that the user comment may be hereinafter referred to as the comment.

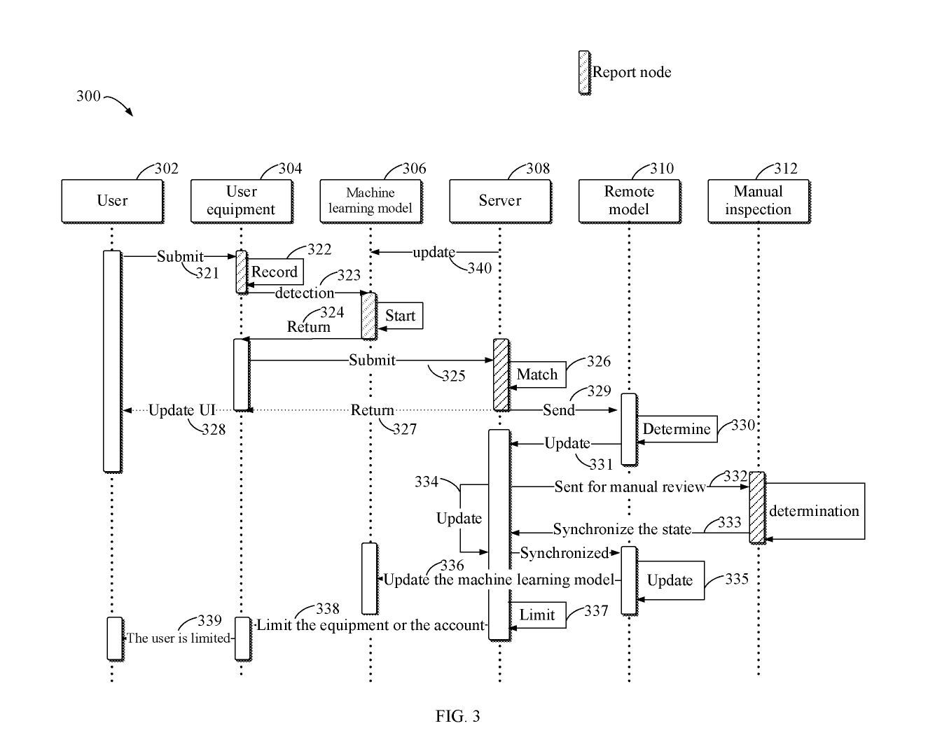

Exemplarily, FIG. 3 illustrates a schematic diagram of an example timing sequence 300 for classifying and detecting user comments according to some embodiments of the present disclosure. FIG. 3 is used to show interaction between entities in a process ranging from the user’s posting of a comment on video content to the comment being classified, detected and processed. In FIG. 3, the entities are a user 302, a user equipment 304, a machine learning model 306, a server 308, a remote model 310, and manual inspection 312, respectively.

In some embodiments, the user 302 is an entity that posts the comment, and can comment on video content posted by other users (or himself or herself). In some embodiments, the user equipment 304 may serve as a carrier or tool through which the user 302 posts the comment. The user equipment 304 may have a display function capable of displaying the comment content that the user 302 is allowed to post.

In some embodiments, the machine learning model 306 may be a lightweight model that can be adapted to run on the user equipment 304. For example, the machine learning model may be some lightweight models that may be deployed to the user equipment 304 using a lightweight open-source machine learning framework so that their dynamic updating can be achieved. These machine learning models deployed on the user equipment 304 may be pre-loaded to perform an offline classification operation of the user comment.

In some embodiments, the server 308 may be configured to further perform a detection operation on the user comment based on a classification result of the user comment. The remote model 310 may be used to further perform a detection operation on the user comment based on a preliminary detection result. The manual inspection 312 is a manual review of the detection result.

In some embodiments, when the user 302 posts a comment, a preliminary classification operation may first be performed on the user comment by the machine learning model 306 to determine a category to which the user comment belongs. Then, a secondary detection operation is performed by means of the server 308 and the remote model 310 and the manual inspection 312 according to the previously obtained category of the user comment and the user comment, to obtain a final detection result. In this way, the comment posted by the user may be subsequently processed adaptively according to the final detection result. This process will be described in detail below with reference to FIG. 3.

Referring to FIG. 3, at 321, the user 302 may submit a comment to the user equipment 304 through his user account. At 322, the user equipment 304 may record a state of the user equipment used by the user 302 (i.e., the user equipment 304), the way the user 302 inputs the comment, and the comment submitted by the user. In some embodiments, the way the user inputs the comment may be the user’s paste way or an automated operation way or a normal input way, such as large-scale copy-and-paste, frequent repeated input, or normal word-by-word input.

In some embodiments, the state of the user equipment may be whether the user equipment has ever been limited. If it has once been banned, this indicates that the user equipment is ever limited. In some embodiments, the state of the user equipment may be whether the user equipment is in a normal state or an abnormal state. For example, the user equipment is in the abnormal state when one of the following conditions occurs comprising but not limited to: the user equipment is configured with a simulator or the user equipment is a jailbroken device.

In some embodiments, whether the user equipment is a simulator may be determined by an identifier and operating environment characteristics of the user equipment; alternatively, whether the user equipment is a simulator may be determined by detecting the file path. In some embodiments, whether the user equipment is a jailbroken device may be determined by detecting whether the user equipment is configured with a jailbroken device and whether there is an action of invoking a jailbroken application interface.

Referring to FIG. 3, at 323, a model detection operation is performed, i.e., the machine learning model 306 determines the category to which the user comments belong, according to the user comment acquired by the user equipment 304, the state of the user equipment, and the way the user inputs the comment. Then, at 324, the machine learning model 306 may return a result to the user equipment 304.

In some embodiments, the categories of the user comment may be classified into high, medium, and low categories, and these categories may be used to indicate a state of compliance of the user comment submitted by the user with a special requirement, or to indicate whether the user comment is normal or abnormal, and to indicate a degree of the abnormality. In other words, the user comment complying with the requirement may be presented to other users, whereas the user comment not complying with the requirement is not allowed to be presented.

By determining the category of the comment posted by the user by virtue of the machine learning machine, on the basis of the user comment itself, and further in conjunction with information including the state of user equipment and the user comment-inputting way, it is possible to improve the accuracy of classification of the user comment and provide effective support for the subsequent detection of the user comment.

Further referring to FIG. 3, after acquiring the category of the user comment as determined by the machine learning model 306, at 325 the user equipment 304 sends the user’s comment and the category of the user comment to the server 308 for further detection of the comment and the category of the comment. At 326, a matching operation is performed, i.e., the user comment and the category to which the user comment belongs are matched with data samples (such as corpus samples) in a server data (such as server corpus) to determine a detection result (namely, a first detection result). The server corpus may include various non-compliant samples such as samples in the form of advertisements and samples in the form of fraudulent content.

If the detection result is normal, then at 327 a state of the submitted comment is returned to the user equipment 304, i.e., the user equipment 304 is informed that the user comment satisfies the requirement and may be presented to other users, and then, at 328, the user interface on which the user submits the comment may be updated. In some embodiments, the matching operation may be performed using a pattern matching algorithm. In some embodiments, when it is detected that the user account through which the user submits the comment is in a whitelist, it may be determined that the detection result of the user comment submitted through the account is normal.

If the detection result is abnormal, then at 329, the comment may be sent for inspection, i.e., sent to the remote model 310 which performs a determination operation, i.e., performs a determination operation on an abnormality probability at 330. In some embodiments, the comment is labelled with a corresponding category.

In some embodiments, the abnormality probability of the comment may be inferred according to the user comment labelled with the category. For example, the remote model 310 may predict the abnormality probability of “comment A” by virtue of a corpus of the remote model and based on “comment A (labelled as high)”. If the remote model 310 determines the abnormality probability of the user comment is 75%, and a preset threshold probability of the abnormality probability is 60%, it may be determined that the detection result (namely, a second detection result) of “comment A” is normal. If the remote model 310 determines that the abnormality probability of the user comment is 75% and a preset threshold probability of abnormality probability is 70%, it may be determined that the detection result of “comment A” is abnormal.

In some embodiments, the abnormality may have abnormality levels. For example, if the abnormality probability is 5% higher than the preset threshold probability, the abnormality level is medium; if the abnormality probability is 10% higher than the preset threshold probability, the abnormality level is high. Therefore, the subsequent processing of abnormal comments is also applicable to different abnormality levels.

In some embodiments, after the remote model 310 determines at 330, an update operation may be performed at 331, i.e., perform the update of the second detection result and offer the updated one to the server 308. If the second detection result is abnormal, it may be sent for manual review at 332, i.e., the user comment whose abnormality probability is above the preset threshold probability and the second detection result may be sent to manual inspection 312, and a manual determination result may be obtained.

Such a method of performing secondary detection on the preliminarily classified user comment and the category of the user comment at the server can effectively improve the accuracy and effectiveness of the detection result of the user comment and thus can further improve the normal users’ experience.

Referring to FIG. 3, if the obtained manual determination result indicates that the user comment is abnormal, then at 333, the state is synchronized, i.e., a result of manual review is synchronized to the server 308. Meanwhile, the server 308 also needs to perform an update operation at 334, i.e., to perform an update of the server data (such as the server corpus). For example, the “comment A” is collected into the server corpus. Meanwhile, the remote model 310 may also be updated synchronously according to the results of the manual review, and meanwhile the update operation is performed at 335, namely, “comment A” is collected into the corpus of the remote model.

Meanwhile, the machine learning model 306 deployed on the user equipment 304 may also be updated at 336. In some embodiments, the update of the machine learning model 306 may be periodic, i.e., an on-demand update operation is performed at 340. For example, a quarterly update may be performed.

In some embodiments, after the server 308 determines that the manually reviewed second detection result is abnormal, a limiting operation may be performed at 337. In other words, a limiting policy is determined for the user account or user equipment corresponding to the user comment.

In some embodiments, the server 308 may also send the detection result of the abnormality to the user equipment 304, wherein the detection result may comprise limitation information for limiting the user equipment or user account. In some embodiments, the abnormality levels may be at least classified as a first abnormality or a second abnormality with a degree of distinction. At 338, the limitation information for limiting the equipment or account is sent to the user equipment 304.

Next, when the user equipment 304 receives an abnormal manually reviewed detection result, the user equipment of the user may be limited if the first abnormality is detected, and the user account of the user may be limited if the second abnormality is detected. Thus, at 339, the user may be limited. In some embodiments, the user equipment 304 limits the display of the use comment according to the detection result, and may limit the user according to the abnormality level, i.e., limit the user account or user equipment. In some embodiments, the user equipment 304 may update the state of the equipment to a limited state if the detection result is abnormal. In some embodiments, a duration of limiting the user account or user equipment may also be determined as appropriate based on the abnormality level. If the duration elapses, the limitation may be automatically released if there is no abnormal action.

In some embodiments, if the user comment is abnormal, the user account and the user equipment will be bound together and recorded in the database for adjusting the parameters of the learning model or remote model.

This method for multi-dimensional classification and detection can effectively improve the efficiency in classifying and identifying the user’s identification so as to provide a decision-making basis for subsequently processing of the detection result of the user comment. Meanwhile, such a method for further detection of the user comment enhances the accuracy and effectiveness of the detection of the user comment, and thereby improves normal user experience in the comment actions.

It should be appreciated that FIG. 3 only illustrates an example timing diagram in which the data is the user comment. The data may also be data in the form of pictures, videos, etc., which is not limited in the present disclosure.

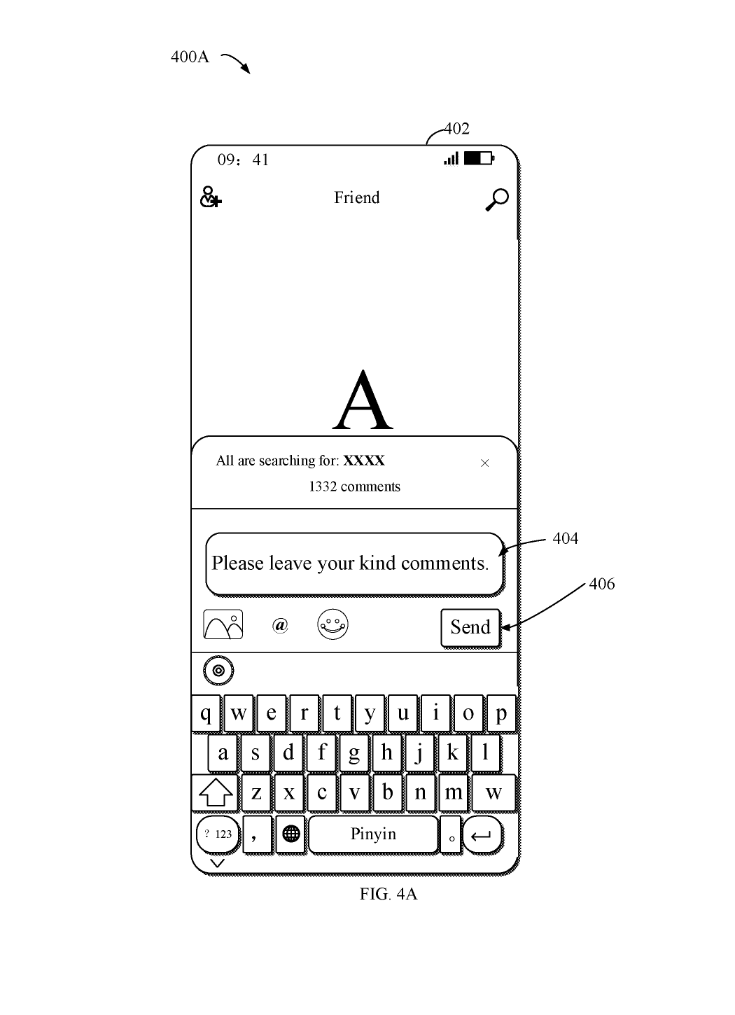

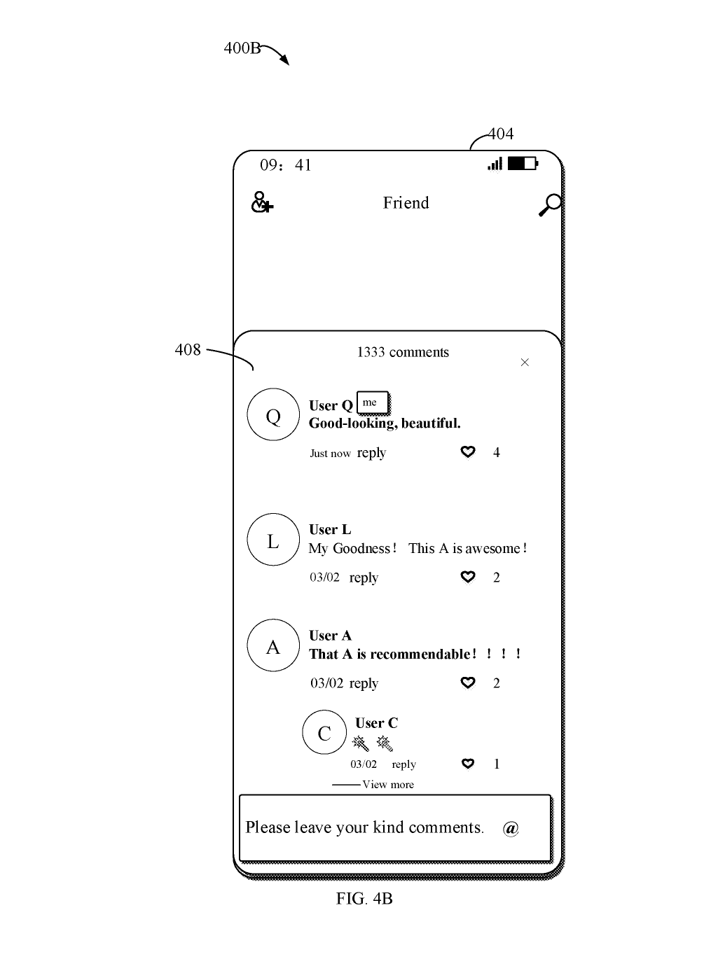

FIGS. 4A-4B illustrate schematic diagrams of example interfaces 400A-400B for a user to post comments according to some embodiments of the present disclosure. As shown in FIG. 4A, a display interface 402 displays a user interface through which a user may submit a comment. At block 404, the user may enter a text of the comment to be submitted and achieve the submission of the comment via a control 406. If the comment is determined as being normal after the classification operation and detection operation are performed on the comment, the normal user’s comment may be displayed in the display interface 402 in conjunction with FIG. 4B. As shown in a comment panel 408, the panel is a comment panel that can be seen by the user himself, and meanwhile the user comment may also be presented to other users.

If the comment is determined as being abnormal after the classification operation and detection operation are performed on the comment, the comment will be limited from being displayed. In addition, the account of the user Q’s account or user equipment might be limited accordingly according to the classification of the abnormality level.

Such a method of limiting the presentation of abnormal comments can create a harmonious communication environment for users and improve users’ experience.

It should be appreciated that FIGS. 4A-4B exemplarily illustrate the example interfaces in which the data is the user comment. The data may also be data in the form of pictures, videos, etc., which is not limited in the present disclosure.

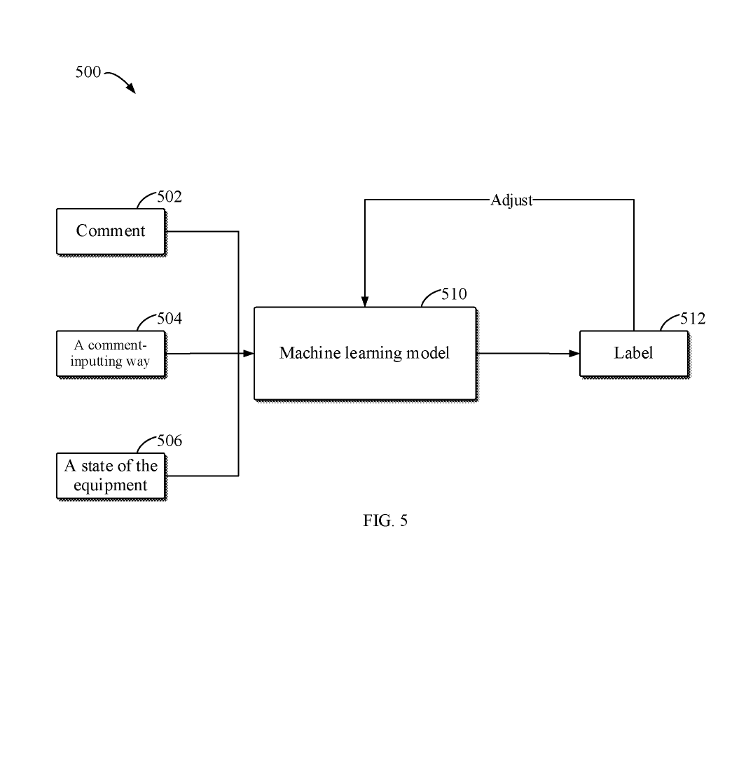

FIG. 5 illustrates a schematic diagram of an example architecture 500 for training a machine learning model according to some embodiments of the present disclosure. As shown in FIG. 5, in some embodiments, a supervised learning framework may be employed to train model parameters of a machine learning model 510. In some embodiments, a set of training data for training the machine learning model 510 is multi-dimensional and may comprise a comment 502, a comment-inputting way 504 and a state 506 of the equipment. In some embodiments, this multi-dimensional set of training data may be obtained by a manual annotation method or generated by a model. With reference to FIG. 3, the multi-dimensional set of training data may be enriched using shadowed modules in FIG. 3.

In some embodiments, the comment 502 may be in the form of a text. If the text content involves to advertising, fraud, etc., the text will be labelled as abnormal. In some embodiments, the comment-inputting way 504 may be a paste input mode, an automatic input mode, a word-by-word input mode, etc. The word-by-word input mode may be labeled as normal, and the paste input mode or the automatic input mode may be labeled as abnormal.

In some embodiments, the state 506 of the equipment may be whether the user equipment has ever been limited. If it has been once banned, this indicates that the user equipment is ever limited. In some embodiments, the state of the user equipment may be whether the user equipment is in a normal state or an abnormal state. For example, the user equipment is in the abnormal state when one of the following conditions occurs comprising but not limited to: the user equipment is configured with a simulator or the user equipment is a jailbroken device. In some embodiments, an ordinary equipment state is tagged as normal, and an equipment ever limited or having a jailbreaking history or being a simulator is tagged with abnormal.

The machine learning model 510 may output a label 512 corresponding to the category of the comment based on the comment 502, the comment-inputting way 504 and the state 506 of the equipment to adjust the machine learning model 510 based on the output label 512 and a real comment label. Training the machine learning model with such a multi-dimensional set of training data enables the machine learning model to improve the accuracy in classifying comments.

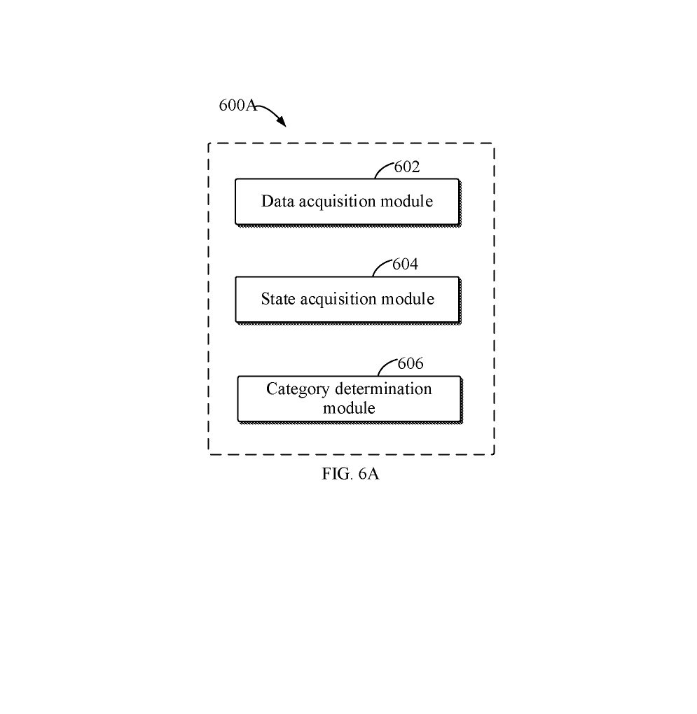

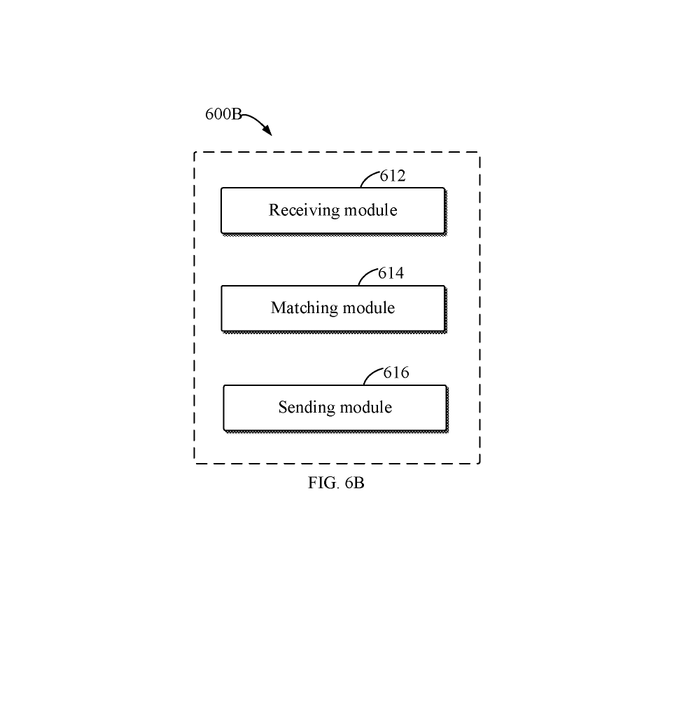

FIGS. 6A-6B illustrate block diagrams of apparatuses 600A and 600B for data classification and data detection according to some embodiments of the present disclosure. As shown in FIG. 6A, the apparatus 600A comprises a data acquisition module 602 configured to acquire data input by a user. The apparatus 600A further comprises a state acquisition module 604 configured to acquire a user action and a state of a user equipment, the user action being associated with a way the user inputs data. In addition, the apparatus 600A further comprises a category determination module 606 configured to determine a category of the data based on the data, the user action and the state.

In some embodiments, the apparatus 600A further comprises: a sending module configured to send the category and the data to a server; and a receiving module configured to receive a detection result from the server, the detection result being determined through data matching based on the category and the data; and an update module configured to update a user interface corresponding to the data based on the detection result, the data comprising a user comment on a video.

In some embodiments, the update module comprises: a display module configured to display the user comment in response to the detection result being normal; and a limiting module configured to limit display of the user comment in response to the detection result being abnormal.

In some embodiments, the abnormality comprises a first abnormality and a second abnormality, wherein the limiting module comprises: a first limiting module configured to limit the user equipment of the user in response to the detection result being the first abnormality; and a second limiting module configured to limit a user account corresponding to the user comment in response to the detection result being the second abnormality.

In some embodiments, the apparatus 600A further comprises: a first update module configured to update the state of the user equipment based on the detection result. In some embodiments, the first update module comprises: a determination module configured to determine, by a machine learning model, the category of the data based on the data, the user action and the state, the machine learning model being an on-device model.

In some embodiments, the apparatus 600A further comprises: a second update module configured to update the machine learning model based on the detection result, the detection result being received from the server, and the detection result being determined through data matching based on the category and the data.

As shown in FIG. 6B, the apparatus 600B comprises a receiving module 612 configured to receive the data and the category of the data from the user equipment, the category being determined based on the data, the user action, and the state of the user equipment. The apparatus 600B further comprises a matching module 614 configured to determine the detection results by matching the data and the category with a server database. In addition, the apparatus 600B further comprises a sending module 616 configured to send the detection result to the user equipment.

In some embodiments, wherein the data comprising a user comment on the video, the user action indicating a way the user posts the comment, the state indicates whether the user equipment has ever been limited, and the server database comprising a server corpus, and matching module 614 comprises: a first determination module configured to determine that the detection result is normal in response to the user account corresponding to the user comment being in a white list.

In some embodiments, wherein the detection result is a first detection result, the comment is labelled with a corresponding category, and the apparatus 600B further comprises: a second determination module configured to determine, by a remote model based on the user comment, a second detection result corresponding to the user comment in response to the detection result being abnormal. In some embodiments, wherein the second determination module comprises: a third determination module configured to determine, by the remote model, an abnormality probability of the user comment based on the user comment; and a fourth determination module configured to determine the second detection result based on the abnormality probability and a preset threshold probability.

In some embodiments, the apparatus 600B further comprises: an acquisition module configured to acquire a review result for the second detection result in response to the second detection result being abnormal; a synchronization update module configured to synchronously update the server corpus in response to the review result of the second detection result being abnormal; and a first update module configured to update the remote model and a remote model database of the remote model, the remote model database comprising a remote model corpus.

In some embodiments, wherein the detection result comprises a second detection result, and the sending module comprises: a limitation information sending module configured to send limitation information to the user equipment in response to the reviewed second detection result being abnormal, the limitation information indicating limitation of at least one of the user equipment and the user account, the detection result comprising the limitation information, the abnormality comprising the first abnormality and the second abnormality.

The apparatus 600A can implement the method for multi-dimensional data classification and detection, thereby effectively improving the efficiency in classifying and detecting the data so as to provide a decision-making basis for subsequent processing of the detection result of the data. Meanwhile, the use of the apparatus 600B can implement the method for further data detection, enhances the accuracy and effectiveness of the data detection, and thereby improves normal user experience in the interaction actions.

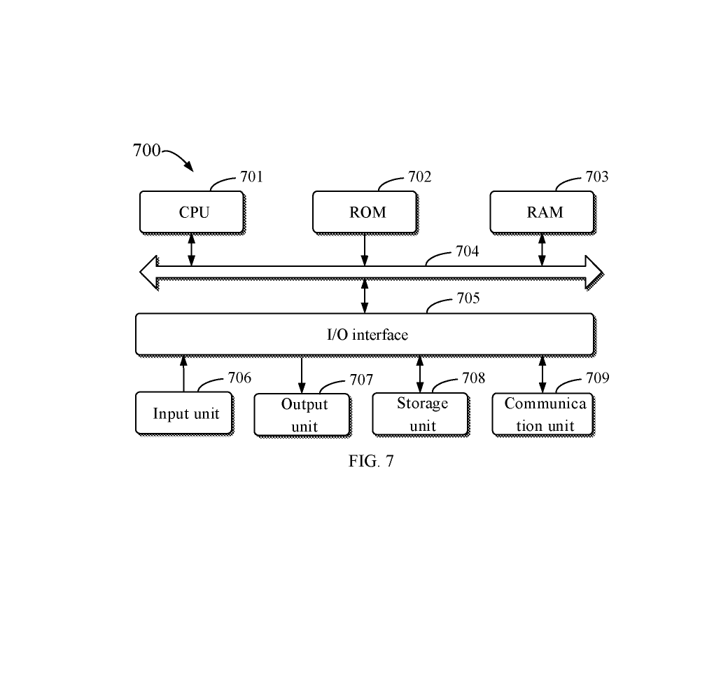

FIG. 7 illustrates a block diagram of a device 700 capable of implementing embodiments of the present disclosure. As shown in FIG. 7, the device 700 comprises a central processing unit (CUP) and/or graphics processing unit (GPU) 701 which may perform various suitable acts and processes in accordance with computer program instructions stored in a Read Only Memory (ROM) 702 or computer program instructions loaded from a storage device 708 into a Random Access Memory (RAM) 703. In the RAM 703, various programs and data needed by the operation of the device 700 are also stored. The CPU/GPU 701, the ROM 702, and the RAM 703 are connected to one another via a bus 704. An input/output (I/O) interface 707 is also coupled to the bus 704. Although not shown in FIG. 7, the device 700 may further comprise a coprocessor.

Multiple components in the device 700 may be connected to the I/O interface 707: an input unit 706 including, for example, a keyboard, a mouse, etc.; an output unit 707 including various displays, speakers etc.; a storage unit 708 such as a magnetic disk, a DC etc.; and a communication unit 709 such as a network card, a modem, a wireless communication transceiver, etc. The communication unit 709 allows the device 700 to exchange information/data with other devices over a computer network, such as the Internet, and/or various telecommunication networks.

The methods or processes described above may be performed by CPU/GPU 701. For example, in some embodiments, the methods may be implemented as a computer software program tangibly embodied on a machine-readable medium, such as the storage unit 708. In some embodiments, part or all of the computer program may be loaded and/or installed on the device 700 via the ROM 702 and/or the communication unit 709. When the computer program is loaded into the RAM 703 and executed by the CPU/GPU 701, one or more steps or actions in the methods or processes described above may be performed.

In some embodiments, the methods and processes described above may be implemented as a computer program product. The computer program product may include a computer-readable storage medium having computer-readable program instructions embodied thereon for performing the aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium comprises the following: a portable computer diskette, a hard disk, a Random Access Memory (RAM), a Read-Only Memory (ROM), an Erasable Programmable Read-Only Memory (EPROM or Flash memory), a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language and conventional procedural programming languages. The computer readable program instructions may execute entirely on the user’s computer, partly on the user’s computer, as a stand-alone software package, partly on the user’s computer and partly on a remote computer or entirely on the remote computer or server. In the scenario involving the remote computer, the remote computer may be connected to the user’s computer through any type of network, including a Local Area Network (LAN) or a Wide Area Network (WAN), or the connection may be made to an external computer (for example, through the Internet using an Internet Service Provider). In some embodiments, electronic circuitry including, for example, programmable logic circuitry, Field-Programmable Gate Arrays (FPGA), or Programmable Logic Arrays (PLA) may execute the computer readable program instructions by utilizing state information of the computer readable program instructions to personalize the electronic circuitry, in order to perform aspects of the present disclosure.

These computer readable program instructions may be provided to a processing unit of a general-purpose computer, a special-purpose computer, or other programmable data processing apparatus to produce a machine, such that the instructions, when executed via the processing unit of the computer or other programmable data processing apparatus, create means for implementing the functions/acts specified in one or more blocks in the flowcharts and/or block diagrams. These computer readable program instructions may also be stored in a computer readable storage medium and cause a computer, a programmable data processing apparatus, and/or other devices to function in a specific way, such that the computer readable storage medium having instructions stored therein comprises an article of manufacture including instructions which implement aspects of the functions/acts specified in one or more blocks in the flowcharts and/or block diagrams.

The computer readable program instructions may also be loaded onto a computer, other programmable data processing apparatus, or other devices to cause a series of operational steps to be performed on the computer, other programmable apparatus or other device to produce a computer-implemented process, such that the instructions executed on the computer, other programmable apparatus, or other devices implement the functions/acts specified in one or more blocks in the flowcharts and/or block diagrams.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special-purpose hardware-based systems that perform the specified functions or acts, or implemented by combinations of special-purpose hardware and computer instructions.

The above depictions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

I claim:

1. A method for data classification, the method comprising:
acquiring data input by a user;
acquiring a user action and a state of a user equipment, the user action being associated with a way the user inputs the data; and
determining a category of the data based on the data, the user action and the state.

2. The method according to claim 1, further comprising:
sending the category and the data to a server;
receiving a detection result from the server, the detection result being determined through data matching based on the category and the data; and
updating a user interface corresponding to the data based on the detection result, the data comprising a user comment on a video.

3. The method according to claim 2, wherein updating the user interface corresponding to the data based on the detection result comprises:
displaying the user comment in response to the detection result being normal; and
limiting display of the user comment in response to the detection result being abnormal.

4. The method according to claim 3, the abnormality comprising a first abnormality and a second abnormality, wherein limiting the display of the user comment in response to the detection result being abnormal comprises:
limiting the user equipment of the user in response to the detection result being the first abnormality; and
limiting a user account corresponding to the user comment in response to the detection result being the second abnormality.

5. The method according to claim 4, further comprising:
updating the state of the user equipment based on the detection result.

6. The method according to claim 1, wherein determining the category of the data based on the data, the user action and the state comprises:
determining, by a machine learning model, the category of the data based on the data, the user action and the state, the machine learning model being an on-device model.

7. The method according to claim 6, further comprising:
updating the machine learning model based on the detection result, the detection result being received from the server, and the detection result being determined through data matching based on the category and the data.

8. A method for data detection, comprising:
receiving data and a category of the data from a user equipment, the category being determined based on the data, a user action and a state of the user equipment;
determining a detection result by matching the data and the category with a server database; and
sending the detection result to the user equipment.

9. The method according to claim 8, wherein the data comprise a user comment on a video, the user action indicates a way the user posts the comment, the state indicates whether the user equipment has ever been limited, and the server database comprises a server corpus, and determining the detection result by matching the data and the category with the server database comprises:
determining that the detection result is normal in response to a user account corresponding to the user comment being in a whitelist.

10. The method according to claim 9, wherein the detection result is a first detection result, the comment is labelled with a corresponding category, and the method further comprises:
determining, by a remote model based on the user comment, a second detection result corresponding to the user comment in response to the detection result being abnormal.

11. The method according to claim 10, wherein determining, by the remote model based on the user comment, the second detection result corresponding to the user comment in response to the detection result being abnormal comprises:
determining, by the remote model, an abnormality probability of the user comment based on the user comment; and
determining the second detection result based on the abnormality probability and a preset threshold probability.

12. The method according to claim 11, further comprising:
acquiring a review result for the second detection result in response to the second detection result being abnormal;
synchronously updating the server corpus in response to the review result of the second detection result being abnormal; and
updating the remote model and a remote model database of the remote model, the remote model database comprising a remote model corpus.

13. The method according to claim 8, wherein the detection result comprises a second detection result, and sending the detection result to the user equipment comprises:
sending limitation information to the user equipment in response to the reviewed second detection result being abnormal, the limitation information indicating limitation of at least one of the user equipment and the user account, the detection result comprising the limitation information, the abnormality comprising a first abnormality and a second abnormality.

14. An electronic device, comprising:
a memory and a processor;
wherein the memory is configured to store one or more computer instructions which, when executed by the processor, cause the processor to:
acquire data input by a user;
acquire a user action and a state of a user equipment, the user action being associated with a way the user inputs the data; and
determine a category of the data based on the data, the user action and the state.

15. The device according to claim 14, further comprising instructions causing the processor to:
send the category and the data to a server;
receive a detection result from the server, the detection result being determined through data matching based on the category and the data; and
update a user interface corresponding to the data based on the detection result, the data comprising a user comment on a video.

16. The device according to claim 15, wherein the instructions causing the processor to update the user interface corresponding to the data based on the detection result comprise instructions causing the processor to:
display the user comment in response to the detection result being normal; and
limit display of the user comment in response to the detection result being abnormal.

17. The device according to claim 16, the abnormality comprising a first abnormality and a second abnormality, wherein the instructions causing the processor to limit the display of the user comment in response to the detection result being abnormal comprise instructions causing the processor to:
limit the user equipment of the user in response to the detection result being the first abnormality; and
limit a user account corresponding to the user comment in response to the detection result being the second abnormality.

18. The device according to claim 17, further comprising instructions causing the processor to:
update the state of the user equipment based on the detection result.

19. The device according to claim 14, wherein the instructions causing the processor to determine the category of the data based on the data, the user action and the state comprise instructions causing the processor to:
determine, by a machine learning model, the category of the data based on the data, the user action and the state, the machine learning model being an on-device model.

20. The device according to claim 19, further comprising instructions causing the processor to:
update the machine learning model based on the detection result, the detection result being received from the server, and the detection result being determined through data matching based on the category and the data.
